(19) United States
(12) Patent Application Publication
(10) Pub. No.: US 2025/0216360 A1
(43) Pub. Date: Jul. 3, 2025

(54) REMOTE CURRENT SENSE

(71) Applicant: JENTEK Sensors, Inc., Marlborough, MA (US)

(72) Inventors: Todd Dunford, Amherst, MA (US); Andrew Washabaugh, Chula Vista, CA (US)

(73) Assignee: JENTEK Sensors, Inc., Marlborough, MA (US)

(21) Appl. No.: 18/850,599

(22) PCT Filed: Mar. 28, 2023
(86) PCT No.: PCT/US2023/065076

§ 371 Date: Sep. 25, 2024

Related U.S. Application Data
(60) Provisional application No. 63/269,986, filed on Mar. 28, 2022.

(51) Int. Cl. G01N 27/90; G01N 27/9013; G01N 27/904

(52) U.S. Cl. CPC G01N 27/9006; G01N 27/902; G01N 27/904; G01N 27/9086

(57) ABSTRACT

An eddy current sensor with a remote current sense has a drive conductor, current sense conductor, and one or more sense conductors. The drive conductor has first and second loop portions, the current sense conductor has a third loop portion, and the sense conductor has a sense loop portion. The first and third loop portions are proximal to each other to form the remote current sense. The sense loop portion and the second loop portion are proximal to each other to form a sense element. The remote current sense and sense element are suitably distant from one another to have separate environments of sensitivity. The sensor may be used by collecting transimpedance measurements from both the remote current sense and sense element under known conditions, and with the sense element under unknown conditions. These measurements are combined to provide a calibrated measurement result suitable for further analysis.

### TECHNICAL FIELD

The technical field of this invention is that of nondestructive materials characterization, particularly quantitative, model-based characterization of surface, near-surface, and bulk material condition for flat and curved parts or components.

### BACKGROUND

Characterization of bulk material condition includes (1) measurement of changes in material state, i.e., degradation/damage caused by fatigue damage, creep damage, thermal exposure, or plastic deformation; (2) assessment of residual stresses and applied loads; and (3) assessment of processing-related conditions, for example from aggressive grinding, shot peening, roll burnishing, thermal-spray coating, welding or heat treatment. It also includes measurements characterizing material, such as alloy type, and material states, such as porosity and temperature. Characterization of surface and near-surface conditions includes measurements of surface roughness, displacement or changes in relative position, coating thickness, temperature and coating condition. Each of these includes detection of electromagnetic property changes associated with either microstructural and/or compositional changes, or electronic structure (e.g., Fermi surface) or magnetic structure (e.g., domain orientation) changes, or with single or multiple cracks, cracks or stress variations in magnitude, orientation or distribution.

A common technique for material characterization is eddy-current testing. Conventional eddy-current sensing involves the excitation of a conducting winding, the primary, with an electric current source of prescribed frequency. This produces a time-varying magnetic field, which in turn is detected with a sensing winding, the secondary. The spatial distribution of the magnetic field and the field measured by the secondary is influenced by the proximity and physical properties (electrical conductivity and magnetic permeability) of nearby materials. When the sensor is intentionally placed in close proximity to a test material, the physical properties of the material can be deduced from measurements of the impedance between the primary and secondary windings. In some cases, only the self-impedance of the primary winding is measured. Traditionally, scanning of eddy-current sensors across the material surface is then used to detect features, such as cracks.

Eddy current inspection typically involves placing a sensor proximate to a test material, exciting the sensor with an electrical signal to create a magnetic field that can be used to interrogate the test material, measuring at least one response from the sensor to assess the condition of the test material, and the appropriate instrumentation for creating the excitation or drive signal and for measuring the response or sense element signal. Often the sensor array has a drive winding to create a magnetic field when driven by an electric current and secondary elements to sense the responses of the material under test (MUT) to the imposed magnetic field. A time-varying current is applied to the primary winding, which creates a magnetic field that penetrates into the MUT and induces a voltage at the terminals of the secondary elements. This terminal voltage reflects the properties of the MUT.

U.S. Pat. No. 6,188,218, Absolute Property Measurement with Air Calibration, Goldfine et al., issued Feb. 13, 2001, describes calibration of an eddy current sensor “in air” and is herein incorporated by reference in its entirety (the '218 patent).

U.S. Pat. No. 10,324,062, Method and apparatus for measurement of material condition, Denenberg et al., issued Jun. 18, 2019, describes a fully parallel, multi-channel impedance instrument and is herein incorporated by reference in its entirety (the '062 patent).

U.S. Pat. No. 6,784,662, Eddy current sensor arrays having drive windings with extended portions, by Schlicker et al, issued Aug. 31, 2004, describes an eddy current sensor array and is herein incorporated by reference in its entirety (the '662 patent).

FIG. 4 provides a schematic 400 of some of the basic components of a transimpedance measurement system. A drive signal 404, typically in the form of a time-varying excitation current, I₁, is used to create the excitation signal inside the drive winding 403 of the sensor array 406. It is common to measure the drive signal current with current sense in instrument 401. Current sense in instrument 401 is either a series resistor or an inductive pick-up coil, proximate to the electronic circuitry used to generate drive signal 404. The sensor array is typically physically located at some distance away from where the drive signal is generated. The electrical connection between these locations is represented by cable 402, which represents the series inductance and resistance along the connecting conductors as well as the parallel capacitance and resistance between the conductors. Multiple sense elements 406 are shown adjacent to the drive winding. The induced voltage on these sense elements is due to the mutual inductance 405 between each sense element 406 and the drive winding 403; this mutual inductance 405 varies with the properties of the test material adjacent to the sensor array.

### SUMMARY

An eddy current sensor with a remote current sense is described as well as a system for using the sensor and a method of use. The drive conductor has first and second loop portions, the current sense conductor has a third loop portion, and the sense conductor has a sense loop portion. The first and third loop portions are proximal to each other to form the remote current sense. The sense loop portion and the second loop portion are proximal to each other to form a sense element. The remote current sense and sense element are suitably distant from one another to have separate environments of sensitivity. The sensor may be used by collecting transimpedance measurements from both the remote current sense and sense element under known conditions, and with the sense element under unknown conditions. These measurements are combined to provide a calibrated measurement result suitable for further analysis.

Some aspects rate to A method comprising acts of (i) providing an eddy current sensor having a sensing element and a remote current sensing element; (ii) measuring simultaneous first responses of the sensing element and the remote current sensing element while the sensing element and the remote current sensing element are in a known environment; (iii) determining a calibration factor from the first responses; (iv) measuring simultaneously second responses of the sensing element and the remote current sensing element, the sensing element proximal to a material under test and the remote current sensing element in the known environment; (v) dividing the second response from the sensing element by the second response from the remote current sensing element to produce a dividend; and (vi) calibrating the dividend by applying the calibration factor.

In some embodiments of the method, the known environment is substantially non-conductive and substantially has the magnetic permeability of free space.

In some embodiments of the method, in act (i), the sensor further has a drive conductor having a first loop portion with a first width and a second loop portion with a second width, the first loop portion separate from and connected to the second loop portion by a lead portion, the remote current sensing element being proximal the first loop portion, and the sensing element proximal the second loop portion. In some embodiments, in act (i), the first loop portion of the drive conducting is separated from the second loop portion by a distance greater than the first width and the second width.

In some embodiments of the method, in act (i), the sensing element is among a plurality of sensing elements forming an array; in act (ii), first responses are measured for each of the plurality of sensing elements; in act (iii), a respective calibration factor is determined for each of the plurality of sensing elements; in act (iv), second responses are measured for each of the plurality of sensing elements; in act (v), the dividing is performed for each of the plurality of sensing elements, and in act (vi), the calibrating is performed for each of the plurality of sensing elements using the respective calibration factor.

In some embodiments of the method, in act (vi) the calibrating is performed by multiplying the dividend by the calibration factor. In some embodiments, act (iii) further comprises determining an offset and act (vi) further comprises adding the offset. In some embodiments determining the offset comprises measuring a third response of the sensing element on a reference material and of the remote current sensing element in the known environment.

In some embodiments of the method, each of the first and second responses each comprise measurement of two scalar quantities measured simultaneously, the two scalar quantities being mathematically equivalent to (I) a real part and an imaginary part, (II) an in-phase component and a quadrature component, or (III) a magnitude and a phase.

In some embodiments of the method, the first and second responses are measured at multiple frequencies simultaneously.

In some embodiments of the method, acts (iv), (v), and (vi) are repeated a plurality of times. In some embodiments, the method further comprises an act of scanning the sensor across a surface of the material under test during the repeating of acts (iv), (v), and (vi). In some embodiments, acts (ii) and (iii) are repeated prior to completing all repetitions of acts (iv), (v), and (vi), and, subsequent the repetition of acts (ii) and (iii) an updated calibration factor is used in subsequent repetitions of act (vi).

Another aspect relates to an eddy current sensor comprising
a drive conductor having a first loop portion with a first width and a second loop portion with a second width, the first loop portion separated from the second loop by a distance greater than the first width and the second width; a current sense conductor having a third loop portion proximal to the first loop portion of the drive conductor; and a sense conductor having a sense loop portion proximal to the second loop portion of the drive conductor.

In some embodiments of the eddy current sensor the drive conductor, the current sense conductor, and sense conductor are each continuous metal structures fabricated on a flexible substrate.

In some embodiments of the eddy current sensor the sense conductor is among a plurality of sense conductors forming an array proximal to the second loop portion of the drive conductor.

Yet another aspect relates to a sensor comprising a plurality of electrical terminals including first, second, third, fourth, fifth and sixth electrical terminals; a drive conductor terminating at the first and second electrical terminals, and having a first loop portion, the first loop portion separate from and connected to the second loop portion by a lead portion; a current sense conductor terminating at the third and fourth electrical terminals, and having a third loop portion proximal the first loop portion of the drive conductor; and a sense conductor terminating at the fifth and sixth electrical terminals, and having a sense loop portion proximal to the second loop portion of the drive conductor.

In some embodiments of the sensor the first loop portion of the drive conductor is separated from the second loop portion by a distance greater than a first width of the first loop portion and a second width of the second loop portion.

In some embodiments of the sensor the sense conductor is among a plurality of sense conductors forming an array, each sense conductor terminating at a respective pair of terminals among the plurality of terminals and a respective sense loop portion proximal to the second loop portion of the drive conductor.

In some embodiments of the sensor an area of the third loop portion is within plus or minus 20 percent of an area of the sense loop portion.

In some embodiments of the sensor the first loop portion is a first Double-D construct and the third loop portion is within an area of the first Double-D construct. In some embodiments the second loop portion is a second Double-D construct and the sense loop portion is within an area of the second Double-D construct.

In some embodiments, the sensors further comprises a connector for electrically connecting to the plurality of terminals.

Yet another aspect relates to a method comprising acts of (i) providing an eddy current sensor having a sensing element and a remote current sensing element; (ii) measuring first responses of the sensing element and the remote current sensing element while the sensing element and the remote current sensing element are in a known environment; (iii) determining a calibration factor from the first responses; (iv) measuring second responses of the sensing element and the remote current sensing element, the sensing element proximal to a material under test and the remote current sensing element in the known environment; (v) dividing the second response from the sensing element by the second response from the remote current sensing element to produce a dividend; and (vi) calibrating the dividend by applying the calibration factor.

The foregoing is a non-limiting summary of the invention, which is defined by the attached claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of system for inspecting a test object, according to some embodiments;

FIG. 2 is a sensor having a remote current sense and a sense element, according to some embodiments;

FIG. 3 is a sensor having a remote current sense and an array of sense elements, according to some embodiments;

FIG. 4 is a block diagram of a conventional system;

FIG. 5 is a block diagram of a system utilizing a sensor with a remote current sense, according to some embodiments;

FIGS. 6, 7, and 8 are example embodiments of eddy current sensors having a linear array of sense elements and a remote current sense, according to some embodiments;

FIG. 9 is a flow diagram of a method for calibrated measurement of a test object using an eddy current sensor having a remote current sense and a sense element, according to some embodiments;

FIG. 10 is a a block diagram of a system for generating calibrated measurement data using a sensor array construct having a remote current sense and an array of sense elements, according to some embodiments;

FIG. 11 shows a partial schematic of a sensor having multiple spatial wavelengths in a substantially circularly symmetric configuration, according to some embodiments;

FIG. 12 shows a partial schematic of a sensor having a Double-D second loop portion of a drive conductor and sense conductors with sense loop portions having multiple spatial wavelengths; and

FIG. 13 shows a sensor with two sensing arrays associated with a single drive winding, according to some embodiments.

### DETAILED DESCRIPTION

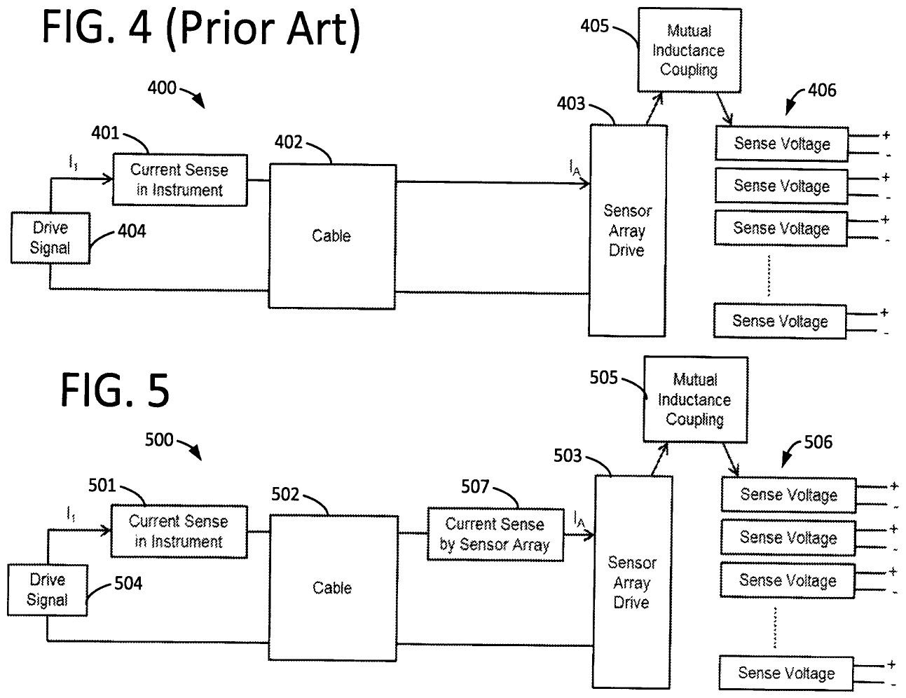

The inventors have recognized and appreciated that a substantial measurement performance limitation with the schematic of FIG. 4 is that the drive current IA into the drive winding 403 can be different from the imposed drive current 11. This is a result of the electrical impedance between the ends of the terminals of cable 402 being dependent upon the excitation frequency and length of cable. Generally the impedance effect of the cable increases with frequency and length of the cable. Consequently, these cable effects create a limit for the upper bound for the excitation frequencies or the cable length that can be used.

The inventors have recognized and appreciated that the ability to operate at high excitation frequencies and to use long cables is important for numerous inspection applications. The higher excitation frequencies, typically of order 10 MHz or higher, is useful for the assessment of low electrical conductivity materials, such as titanium, nickel superalloys, and non-magnetic stainless steels; the high excitation frequencies can be used to provide improved detectability to defect conditions such as surface breaking cracks. The high excitation frequencies are also useful for the inspection of metal powders such as those used for additive manufacturing methods.

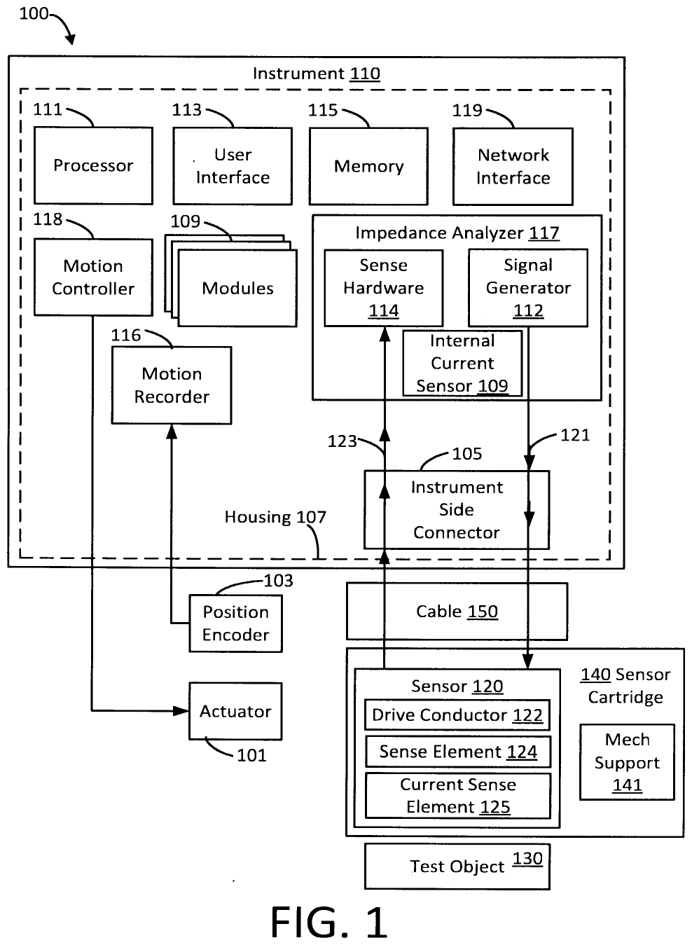

Accordingly, aspects of some embodiments relate to the use of a system 100 for inspecting a test object 130. System 100 is shown as a block diagram in FIG. 1. System 100 includes an instrument 110 and a sensor cartridge 140. Instrument 110 may be housed in a housing 107; in some embodiments the housing is substantially cylindrical in shape such as that described in U.S. Pat. No. 10,416,118, Measurement system and method of use, by Goldfine et al. issued Sep. 17, 2019 and herein incorporated by reference in its entirety (the '118 patent). Sensor cartridge 140 may have a rigid connector which interfaces both mechanically and electrically with an instrument side connector 105.

In some embodiments, sensor cartridge 140 is connected to instrument side connector 105 via cable 150. Cable 150 may be of arbitrary length in accordance with the requirements of the application. Although cable 150 is shown with only excitation signals 121 and response signals 123 passing through it, it should be appreciated that cable 150 may also convey other signals (including power). For example, power and/or measurement signals for position encoder 103 may be conveyed through cable 150. Similarly, power and/or control signals for actuator 101 may be conveyed through cable 150.

In some other embodiments, sensor 120 is directly connected to instrument side connector 105. Sensor cartridge 140 in some embodiments also includes a flexible sensor 120, and a mechanical support 141 to which the sensor is attached. Sensor 120 may be attached to mechanical support 141 with glue, tape, double sided tape, or in any suitable way. Instrument 110 is configured to provide excitation signals 121 to sensor 120 and measure the resulting response signals 123 of sensor 120. Response signals 123 may be measured and processed to estimate properties of interest, such as electromagnetic properties (e.g., electrical conductivity, permeability, and permittivity), geometric properties (e.g., layer thickness, sensor liftoff), material condition (e.g., fault/no fault, crack size, layer to layer bond integrity, porosity, residual stress level, temperature), or any other suitable property or combination thereof including properties of the fabricated part and the powder. (Sensor liftoff is a distance between the sensor and the closest surface of the test object for which the sensor is sensitive to the test object's electrical properties.)

Instrument 110 may include a processor 111, a user interface 113, memory 115, an impedance analyzer 117, and a network interface 119. Though, in some embodiments of instrument 110 may include other combinations of components. While instrument 110 is drawn with housing 107, it should be appreciated that instrument 110 may be physically realized as a single mechanical enclosure; multiple, operably-connected mechanical enclosures, or in any other suitable way. For example, in some embodiments it may be desired to provide certain components of instrument 110 as proximal to sensor 120 as practical, while other components of instrument 110 may be located at greater distance from sensor 120.

Processor 111 may be configured to control instrument 110 and may be operatively connected to memory 115. Processor 111 may be any suitable processing device such as for example and not limitation, a central processing unit (CPU), digital signal processor (DSP), controller, addressable controller, general or special purpose microprocessor, microcontroller, addressable microprocessor, programmable processor, programmable controller, dedicated processor, dedicated controller, or any suitable processing device. In some embodiments, processor 111 comprises one or more processors, for example, processor 111 may have multiple cores and/or be comprised of multiple microchips. Processing of sensor data and other computations such as for control may be performed sequentially, in parallel, or by some other method or combination of methods.

Memory 115 may be integrated into processor 111 and/or may include “off-chip” memory that may be accessible to processor 111, for example, via a memory bus (not shown). Memory 115 may store software modules that when executed by processor 111 perform desired functions. Memory 115 may be any suitable type of non-transient computer-readable storage medium such as, for example and not limitation, RAM, a nanotechnology-based memory, optical disks, volatile and non-volatile memory devices, magnetic tapes, flash memories, hard disk drive, circuit configurations in Field Programmable Gate Arrays (FPGA), or other semiconductor devices, or other tangible, non-transient computer storage medium.

Instrument 110 may have one or more functional modules 109. Modules 109 may operate to perform specific functions such as processing and analyzing data. Modules 109 may be implemented in hardware, software, or any suitable combination thereof. Memory 115 of instrument 110 may store computer-executable software modules that contain computer-executable instructions. For example, one or more of modules 109 may be stored as computer-executable code in memory 115. These modules may be read for execution by processor 111. Though, this is just an illustrative embodiment and other storage locations and execution means are possible.

Instrument 110 provides excitation signals for sensor 120 and measures the response signal from sensor 120 using impedance analyzer 117. Impedance analyzer 117 may contain a signal generator 112 for providing the excitation signal to sensor 120. Signal generator 112 may provide a suitable voltage and/or current waveform for driving sensor 120. For example, signal generator 112 may provide a sinusoidal signal at one or more selected frequencies, a pulse, a ramp, or any other suitable waveform. Signal generator 112 may provide digital or analog signals and include conversion from one mode to another. The '062 patent provides a discussion of an impedance analyzer that may be used in some embodiments. See, for example, the discussion in connection with FIG. 19a which provides a discussion on how impedance analyzer 117 can take a measurement. The '218 patent provides further discussion on how such impedance measurements may be calibrated to remove certain systematic bias from the measurements.

In some embodiments, impedance analyzer 117 has a current sensor 109 that is used to measure a current leaving signal generator 112. Current sensor 109 may be any suitable sensor for measuring such current. For example, current sensor 109 may include a known series resistance in the drive current signal path and current sensor 109 may measure the voltage across such known resistance such that the current may be calculated using Ohm's Law. As another example, current sensor 109 may measure the voltage induced on an inductive pick-up coil having a well known transimpedance.

Sense hardware 114 may comprise multiple sensing channels for processing multiple sensing element responses in parallel. As there is generally a one to one correspondence between sense elements and instrumentation channels these terms may be used interchangeably. It should be appreciated that care should be used, for example, when multiplexing is used to allow a single channel to measure multiple sense elements. For sensors with a single drive and multiple sensing elements such as the MWM®-Array eddy current array available from JENTEK® Sensors, Inc., the sensing element response may be measured simultaneously at one or multiple frequencies including simultaneous measurement of real and imaginary parts of the transimpedance (or mathematically equivalent measurements/representations such as the magnitude and phase of the transimpedance or the in-phase and quadrature components of the transimpedance). Though, other configurations may be used. For example, sense hardware 114 may comprise multiplexing hardware to facilitate serial processing of the response of multiple sensing elements and for eddy current arrays. Some embodiments of sensor 120 use certain MWM-Array formats to take advantage of the linear drive and the ability to maintain a consistent eddy current pattern across the part using such a linear drive. Sense hardware 114 may measure sensor transimpedance for one or more excitation signals at one or more sense elements 124 of sensor 120. It should be appreciated that while transimpedance (sometimes referred to simply as impedance), may be referred to as the sensor response, the way the sensor response is represented is not critical and any suitable representation may be used. In some embodiments, the output of sense hardware 114 is stored along with temporal information (e.g., a time stamp) to allow for later temporal correlation of the data, and positional data correlation to associate the sensor response with a particular location on test object 130. Instrumentation may also operate in a pulsed mode with time gates used to provide multiple sensing outputs and multiple channels used to acquire data from multiple sensing elements. If these sensing elements 124 have different drive-sense gaps (distance between a drive conductor 122 and the sense elements 124, then this is referred to as a segmented field sensor. Thus, sensor operation can be at a single frequency, multiple frequencies, or in a pulsed mode where the drive is turned on and off in a prescribed manner or switched between two or more modes of excitation.

Sensor 120 is shown as an eddy-current sensor, though other sensor types may be used with system 100. Sensor 120 has a drive conductor 122, a sense element 124 (or multiple sense elements), and a current sense element 125, each of which is discussed further herein. In some embodiments sensor 120 provides temperature measurement, voltage amplitude measurement, strain sensing or other suitable sensing modalities or combination of sensing modalities. In some embodiments, sensor 120 is an eddy-current sensor such as an MWM, MWM-Rosette, or MWM-Array sensor available from JENTEK Sensors, Inc., Marlborough, MA. A discussion of some MWM-Array sensors may be found. for example, in the '662 patent. Sensor 120 may be a magnetic field sensor or sensor array such as a magnetoresistive sensor (e.g., MR-MWM-Array sensor available from JENTEK Sensors, Inc.), a segmented field MWM sensor, and the like. Segmented field sensors have sensing elements at different distances from the drive winding to enable interrogation of a material to different depths at the same drive input frequency. Sensor 120 may have a single or multiple sensing and drive elements. Sensor 120 may be scanned across, mounted on, or embedded into test object 130.

In some embodiments, the computer-executable software modules 109 may include a sensor data processing module that, when executed, estimates properties of test object 130. The sensor data processing module may utilize multi-dimensional precomputed databases that relate one or more frequency transimpedance measurements to properties of test object 130 to be estimated. The generation of suitable databases and the implementation of suitable multivariate inverse methods are described, for example, in U.S. Pat. No. 7,467,057, issued on Dec. 16, 2008 (the '057 patent), and U.S. Pat. No. 8,050,883, issued on Nov. 1, 2011 (the '883 patent), both of which are herein incorporated by reference in their entirety. The sensor data processing module may take the precomputed database and sensor data and, using a multivariate inverse method, estimate material properties for the processed part or the powder. Though, the material properties may be estimated using any other analytical model, empirical model, database, look-up table, or other suitable technique or combination of techniques.

User interface 113 may include devices for interacting with a user. These devices may include, by way of example and not limitation, keypad, pointing device, camera, display, touch screen, audio input and audio output.

Network interface 119 may be any suitable combination of hardware and software configured to communicate over a network. For example, network interface 119 may be implemented as a network interface driver and a network interface card (NIC). The network interface driver may be configured to receive instructions from other components of instrument 110 to perform operations with the NIC. The NIC provides a wired and/or wireless connection to the network. The NIC is configured to generate and receive signals for communication over network. In some embodiments, instrument 110 is distributed among a plurality of networked computing devices. Each computing device may have a network interface for communicating with other computing devices forming instrument 110.

In some embodiments, multiple instruments 110 are used together as part of system 100. Such systems may communicate via their respective network interfaces. In some embodiments, some components are shared among the instruments. For example, a single computer may be used to control all instruments. In one embodiment multiple areas on the test object are scanned using multiple sensors simultaneously or in an otherwise coordinated fashion to use multiple instruments and multiple sensor arrays with multiple integrated connectors to inspect the test object surface faster or more conveniently.

Actuator 101 may be used to position sensor cartridge 140 with respect to test object 130 and ensure that the liftoff of the sensor 120 is in a desired range relative to the test object 130. Actuator 101 may be an electric motor, pneumatic cylinder, hydraulic cylinder, or any other suitable type or combination of types of actuators for facilitating movement of sensor cartridge 140 with respect to test object 130. Actuators 101 may be controlled by motion controller 118. Motion controller 118 may control sensor cartridge 140 to move sensor 120 relative to test object 130.

Regardless of whether motion is controlled by motion controller 118 or directly by the operator, position encoder 103 and motion recorder 116 may be used to record the relative positions of sensor 120 and test object 130. This position information may be recorded with impedance measurements obtained by impedance analyzer 117 so that the impedance data may be spatially registered.

For some applications the performance of system 100 depends (among other things) on the proximity of sensor 120 to test object 130; that is to say the sensor liftoff may be critical to performance for such applications. For example, crack detection in an aerospace application may require cracks 0.5 mm (0.02 inches) in length be reliably detectable in test object 130 (e.g., a turbine disk slot). In order to achieve reliable detection of a small crack, sensor 120's liftoff may need to be kept to under 0.25 mm (0.010 inches). Further, for such an application, sensor 120 may preferably be a sensor array, thus the liftoff of each element in the array may need to be kept to under 0.25 mm (0.010 inches). (It should be appreciated that these dimensions are illustrative and the specific requirements will be dictated by the details of the application.) Measurements may be complicated when test object 130 has a complex curved surface that may change along a measurement scan path.

To permit high-performance operation at higher excitation frequencies, use of current sensor 109 to measure the current in drive conductor 122 may not be sufficient. The inventors have recognized and appreciated that measurement performance may be improved by measuring the current in drive conductor 122 closer to the portion of the drive conductor that is inductively coupling to sense element 124. Specifically, a current sense element 125 located on sensor 120 can be used to much more accurately measure the current in drive conductor 122 that is inductively coupling to sense element 124. This is contrasted with measurement of the drive current much further from sense element 124 using current sensor 109 which is typically within instrument housing 107. Although the electrical impedance of cable 150 may alter the current at the instrument, the local measurement can account for any variation of the current due to the cable.

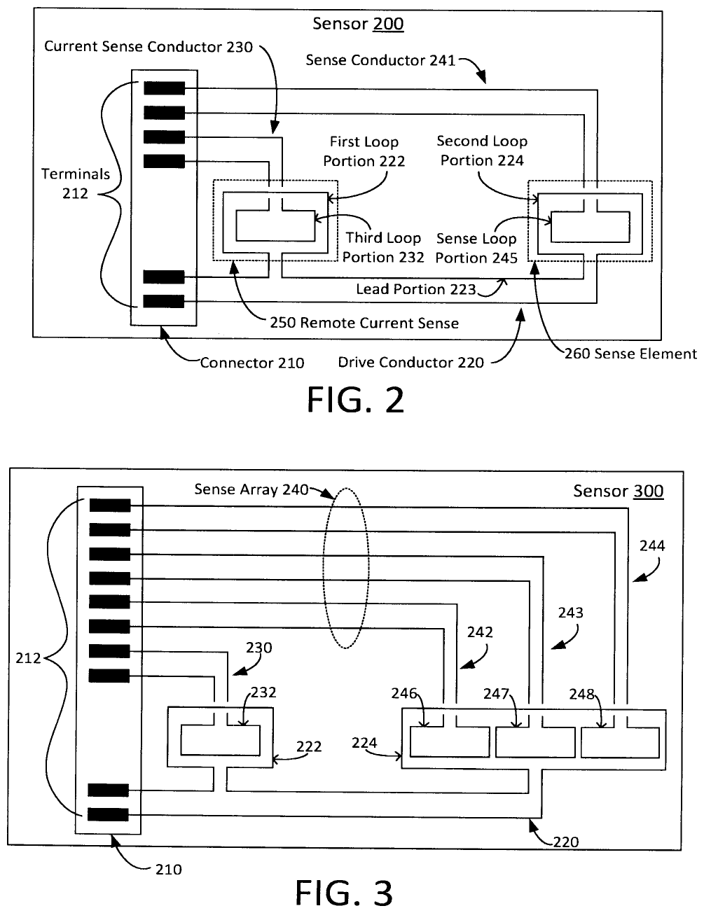

FIG. 2 shows a sensor 200 according to some embodiments. Sensor 200 has a drive conductor 220, a current sense conductor 230, and a sense conductor 241. Drive conductor 220, current sense conductor 230, and sense conductor 241 each terminate at a respective two terminals 212 on a connector 210. Sensor 200 may be used as sensor 120 in FIG. 1. More specifically, as part of system 100, connector 210 of sensor 200 may be connected to cable 150 or directly connected to instrument side connector 105. Note that current sense conductor 230 and a sense conductor 241 are each continuous conductors from terminal to terminal; the illustrated line break near first loop portion 222 and second loop portion 224, respectively, of drive conductor 220 are simply to show that the conductor passes under and/or above drive conductor 220 in the illustrated embodiment. Such may be achieved, for example, using multilayer fabrication techniques.

Current sense conductor 230 has a third loop portion 232 that is positioned to inductively couple with a first loop portion 222 of drive conductor 220. This construct may be referred to as a remote current sense 250. Current sense conductor 230 may be connected to sense hardware 114 via connector 210 such that a voltage induced on current sense conductor 230 may be measured by impedance analyzer 117. This voltage may then be used to determine the current in drive conductor 220 based on a known transimpedance between the first loop portion 222 of drive conductor 220 and the third loop portion 232 of the current sense conductor 230.

In order for the transimpedance associated with remote current sense 250 to be sufficiently constant, remote current sense 250 should be in a known environment. That is, the properties of the environment that materially affect the transimpedance are sufficiently stable so that the transimpedance is substantially unchanging and thus can serve as a reliable reference. In some embodiments, the known environment is air or the materials influencing the transimpedance of remote current sense 250 all have substantially the same relevant properties as air. An eddy current sensor can be modeled as having sensitivity to material electrical conductivity and magnetic permeability. For some applications, modeling air as non-conductive (σ=0) and magnetically non-permeable (i.e., having the permeability of free space, uo) is suitable. Many materials, such as some plastics or foams, have substantially these properties and thus in some embodiments the known environment which materially influences remote current sense 250's transimpedance may be filled with solid materials to mechanically prevent a conductive (i.e., σ=0) or magnetic (i.e., μ≠μₒ) material from entering a proximity that would alter its transimpedance. Of course, a conductive or magnetic material (or materials) could also be used as a known environment to fix the transimpedance of remote current sense 250, however, it may be critical that these materials are sufficiently stable such that the transimpedance relationship is sufficiently constant. Stray materials should be kept to distances sufficient to avoid changing the transimpedance of remote current sense 250.

Sense conductor 241 has a sense loop portion 245 that is positioned to inductively couple with a second loop portion 224 of drive conductor 220 forming sense element 260. Sense conductor 241 may be connected to sense hardware 114 via connector 210 such that a voltage induced on current sense conductor 241 may be measured by impedance analyzer 117. This voltage may then be used to determine a transimpedance of sense element 260. In some applications, sense element 260 is placed proximal to a test object during measurement of the transimpedance and subsequent processing may be used to determine one or more properties of the test object.

Drive conductor 220 is a conductive path for providing a drive current to remote current sense 250 and sense element 260. Drive conductor 220 may terminate at two terminals 212 of connector 210. Drive conductor 220 connects first loop portion 222 and second loop portion 224 in series via lead portion 223.

In some embodiments, first loop portion 222 and second loop portion 224 are located at a suitable distance such that the environment substantially influencing the transimpedance of remote current sense 250 and the environment substantially influencing the transimpedance of sense element 260 do not overlap. In some embodiments, remote current sense 250 and sense element 260 are located at a suitable distance such that the environment substantially influencing the transimpedance of remote current sense 250 and the environment substantially influencing the transimpedance of sense element 260 do not overlap.

In some applications a characteristic length may be defined for each of the remote current sense 250 and sense element 260 and sensor 220 designed such that the distance between remote current sense 250 and sense element 260 (or a specific element thereof such as their drive loop portions) are a distance greater than a multiple of such characteristic length. For example, sensor 220 may be designed that such distance is at least 1, 2, 3, 4, 5, 6, 7, 8, 9, 10 or more times the larger of the characteristic lengths. The characteristic length may be defined as the distance between the closest leg of the drive loop portion and the center of the sense loop portion (the “drive-sense gap”), the width of the drive loop portion, the length of the drive loop portion, or any other suitable characteristic length. For example with reference to sensor 200, the characteristic length of first loop portion 222 may be defined as its width (the “first width”), and the characteristic length of second loop portion 224 may be defined as its width (the “second width”), and the distance between first loop portion 222 and second loop portion 224 may be greater than the first width and the second width (or some multiple of the larger thereof). The distance may be measured as the shortest distance the nearest points of remote current sense 250 and sense element 260. It should be appreciated that this distance serves primarily as a design rule of thumb with the goal of ensuring the magnetic fields of the remote current sense 250 and sense element 260 do not overlap. In some embodiments, remote current sense 250 and sense element 260 are designed to have the same characteristic length (including embodiments where sense element 260 is part of an array).

FIG. 3 shows a sensor 300 that is substantially similar to sensor 200 except that it has a sensor array 240 which is made up of current sense conductors 242, 243, and 244. Current sense conductors 242, 243, and 244 are similar to current sense conductor 241 described in connection to FIG. 2. Each has a sense loop portion (246, 247, and 248, respectively). The illustration of sensor array 240 having three elements is arbitrary and array 240 may be made of two or more elements. Note that second loop portion 224 of drive conductor 220 is common to each of sense loop portions 246, 247, and 248. Also note that the relevant characteristic length the sense elements formed by second loop portion 224 and sense loop portions 246, 247, and 248 is substantially the same as it is for sense element 260 in FIG. 2 and it is not appropriate to treat the lateral length of second loop portion 224 as the characteristic length.

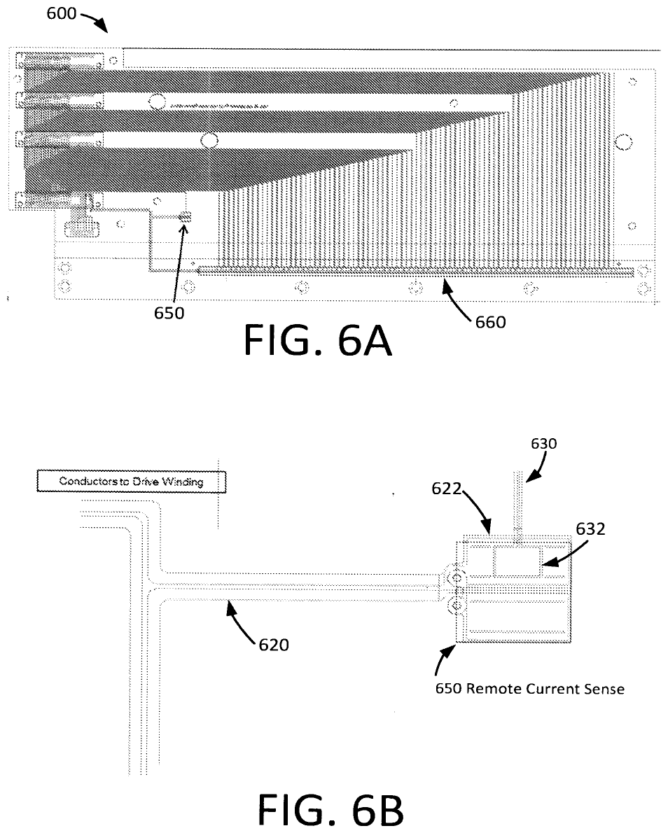

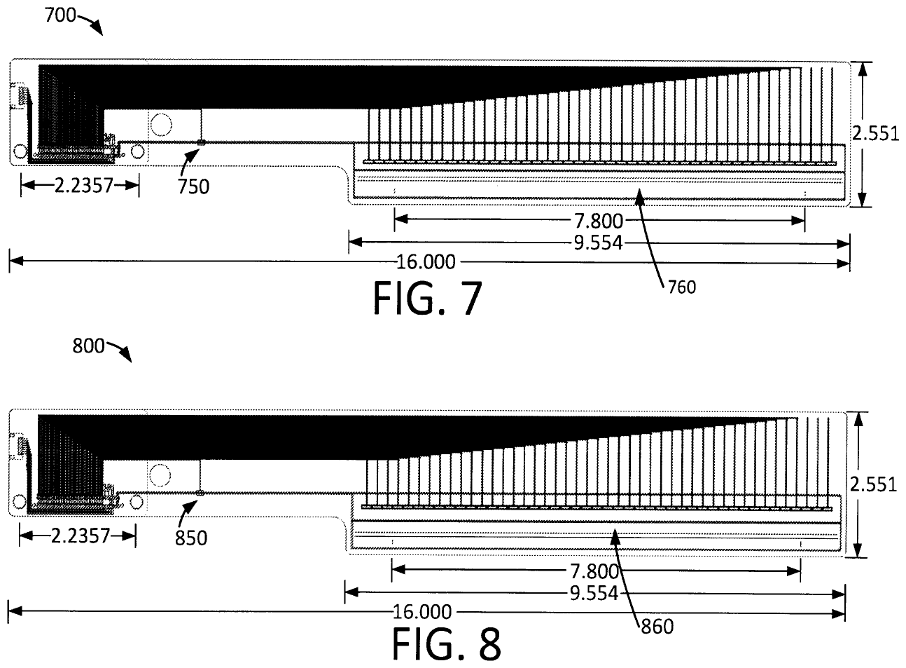

It should be appreciated that the sensing element configurations shown in FIGS. 2 and 3 are simple illustrations. Any suitable formation of sensing elements to achieve inductive coupling between the second loop portion of the drive conductor and sense loop portion(s) of sense conductor(s) may be used. For example, the second loop portion may have a structure such as the “double-D” structure shown in sensor 600 (FIG. 6), sensor 700 (FIG. 7) and sensor 800 (FIG. 8) discussed further below. The double-D structure of a second loop portion has two adjacent (typically) rectangular loops connected in series such that, when excited by a current, the adjacent portions will carry the current in the same direction.

FIG. 5 shows a schematic of a system 500 having a remote current sense 507. System 500 generates a drive signal 504 which produces a current I₁, the may be measured locally by local current sense 501 within the instrumentation. The current passes through cable 502 and connects to a sensor array drive 503. Remote current sense 507 utilizes a sense element for measuring the current through sensor array drive 503, IA. Because of the impedance of cable 502, current I_{A} measured on the sensor, may be different from current I₁ measured within the instrument. The current measurement is used with sense voltages measured on the sensor array 506 (induced due to inductive coupling 505) to determine the transimpedance of each sensing element of the sensor array.

FIG. 6A shows the design of sensor 600, a commercially available MWM-Array sensor of type FA332. Sensor 600 has a drive conductor with a double-D second loop portion. Seventy-nine sense elements are positioned within one “D” of the double D forming sense elements 660. Several connectors are located at the left of the schematic while the active area for the sensor array is along the bottom portion of the schematic. The large connectors on the left side of the image provide the electrical connections to cables and the impedance measurement instrumentation. The drive conductor is provided in the bottom-most of the large connectors. The drive conductor has a first loop portion that, a third loop portion of a current sense conductor 630 forms remote current sense 650 which may be used to obtain a measurement of the drive conductor current that may more accurately reflects the current in the second loop portion of the drive than a current measurement taken within the measurement instrumentation.

FIG. 6B shows a detailed view of remote current sense 650 of sensor 600. In this case the first loop portion 622 of drive conductor 620 also has a double D structure. The combined geometry of first loop portion 622 of drive conductor 620 and third loop portion 632 of current sense conductor 630 is similar to that of the sensor array, except that remote current sense 650 is only a single sense element. The connecting leads for the remote current sense element also have the same type of layout as the leads to the sense elements of the sensor array; this helps to ensure that the signal level and response of the remote current sense is similar to the responses of the elements in the sensor array. While it is preferable to have the magnitude of the remote current sense element response be within 10% of the response of the elements of the sensor array to a test material such as air, this approach may also be used even with substantially larger difference such as, for example, of 50%.

While FIG. 6A shows the remote current sense having a geometry similar to that of the sensor array, it is not necessary for the geometries to match. The number of drive winding loops, the number of turns for each drive winding or sense winding loop, the gaps between the drive winding and the sense elements, the widths of the drive and sense windings, and the overall shape can be different. In some embodiments of sensor 600 and all other sensors discussed, the current sense element uses a resistor of a known value in series with the drive conductor in place of the first loop portion and third loop portion. In such a case the current sense conductor may be electrically connected across the resistor so that the voltage across the resistor can be measured and used to provide the current measurement. However, the voltage across the resistor may have a different frequency dependence than the frequency dependence across a mutual inductance and thus may be less accurate than the remote current sense elements illustrated in the drawings.

FIG. 7 shows a sensor 700 having a 39-channel sensor array. Sensor 700 is a commercially available MWM-Array as type FA336. The remote current sense 750 is placed directly along the linear portion of the drive winding between the connector region on the left and the sensor array region on the right. FIG. 8 shows a sensor 800, another example of a 39 channel sensor array commercially available from JENTEK Sensors, Inc. and of type FA338. Sensor 800 has a larger drive-sense gap (the distance between the sense elements in the array and central portions of the drive winding loops) compared to the sensor 700. However, the location of the remote current sense construct relative to the connector and the sensor array is the same in both cases.

One of the considerations for the remote current sense is the location relative to the connectors and the active area of the sensor array. The active area for the sensor array refers to the region containing the drive winding loops used to generate the sensing magnetic field and the sense elements. The remote current sense element should be located relatively close to the active area for the sensor array so that the impedance due to the conducting pathways between the remote current sense and the sensor array drive winding will not be substantial and the remote current sense response will accurately provide a measure of the drive current. However, the remote current sense should not be located too close to the drive winding or stray magnetic fields from the drive winding could extend to the remote current sense and affect the response. Generally, as long as the remote current sense is at least one spatial wavelength (taken as the shorter distance across the rectangular drive winding loops) this stray coupling is not significant.

In addition, it is desirable for the remote current sense to be located in a fixed position such that the response is not affected by any nearby magnetic and/or conducting materials. Since the sensor array is typically attached to a fixture for ease of handling, this requirement can be satisfied by locating the remote current sense at a position that is at least one spatial wavelength from the test material and any other magnetic and/or conducting materials used in the fixture. For example, the sensor array can be attached to a substantially non-conducting plastic material that is thick enough for remote current sense to be placed in a plane parallel to the active area for the sensor array. Note that magnetic and/or conducting materials can be placed on one or both sides of the remote current sense, but the position of these materials should remain constant between the calibration of the array and the data acquired during the inspection. Otherwise, the presence of these materials could affect the measurement of the drive current.

A convenient location for the remote current sense is approximately half-way between the connectors and the drive windings for the sensor array. Note that mechanical stability can be achieved by placing the remote current sensor against a flat support material; mounting the remote current sense around a bend or a corner of the fixture material could lead to motion of the remote current sense and geometry changes that could affect the measurement of the drive current.

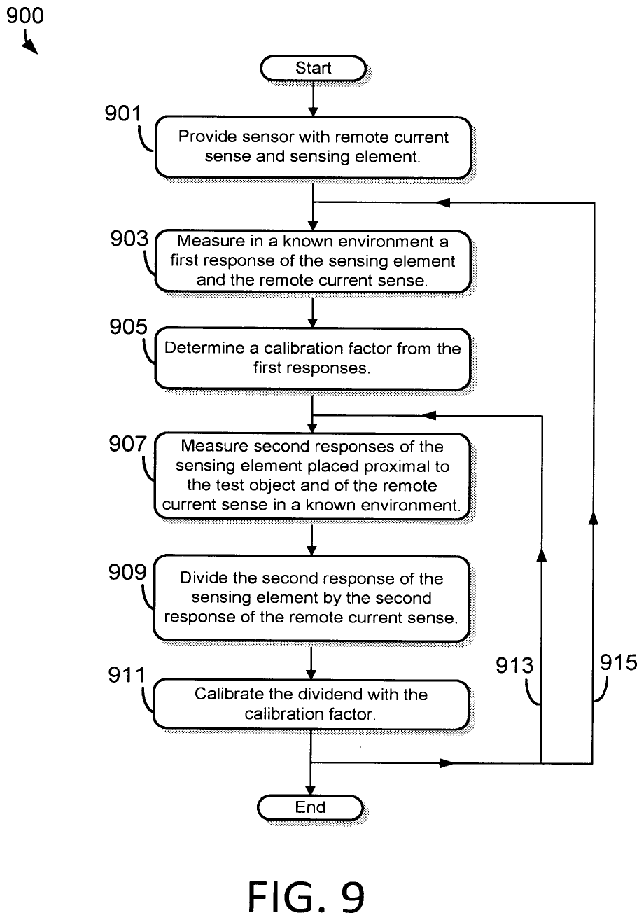

Attention is now turned to FIG. 9 which shows a flow diagram of method 900 according to some embodiments.

At step 901, a sensor with a remote current sense and a sensing element is provided. The provided sensor may be any of such sensors described herein such as, for example, sensors 200, 300, 600, 700, 800, 1100, 1200, and 1300.

At step 903, method 900 measures in a known environment a first response of the remote current sense and a first response of the sensing element. The known environment may be in air, or any other suitable environment such that the transimpedances of the remote current sense and the sensing element may be known. The measurements may be taken simultaneously. By taking the measurements simultaneously the impedance of the leads (e.g., through a cable) to the remote current sense and sensing element will be substantially similar for both elements.

At step 905, method 900 determines a calibration factor from the first responses. The calibration factor may be determined in ways similar to those used in the '218 patent for analogous measurements. In some embodiments the calibration factor is a complex number.

A step 907, method 900 measures second responses of the sensing element placed proximal to a test object and of the remote current sense in a known environment. In some embodiments, the known environment is the same known environment used at step 903. Though a different known environment may be used in some embodiments.

At step 909, method 900 divides the second response of the sensing element by the second response of the remote current sense to produce a dividend. The dividend may be a complex number in some embodiments.

At step 911, method 900 calibrates the dividend with the calibration factor. In some embodiments the calibration occurs by multiplying the dividend by the calibration factor.

Method 900 may end after step 911. The calibrated result produced by method 900 may be used in subsequent processes such as in a multivariate inverse method to estimate material properties of the test object. Such calibrated results and/or material properties may be used to control a process or determine whether the test object should be approved, scraped, reworked, or otherwise treated. Though the sensor, system and method described here may be used as a measurement tool and thus the use of the calibrated result may vary greatly from embodiment to embodiment.

In some embodiments, after step 911 method 900 continues via path 913 and returns to step 907 and repeats steps 907, 909, and 911 one or more additional times. This may be the case, for example, in a scanning application where data is taken repeatedly as a sensor is scanned across the test object.

Method 911 may also continue after step 911, via path 915, to step 903 and continue from that point. Paths 913 and 915 may each be taken multiple times before method 900 ends.

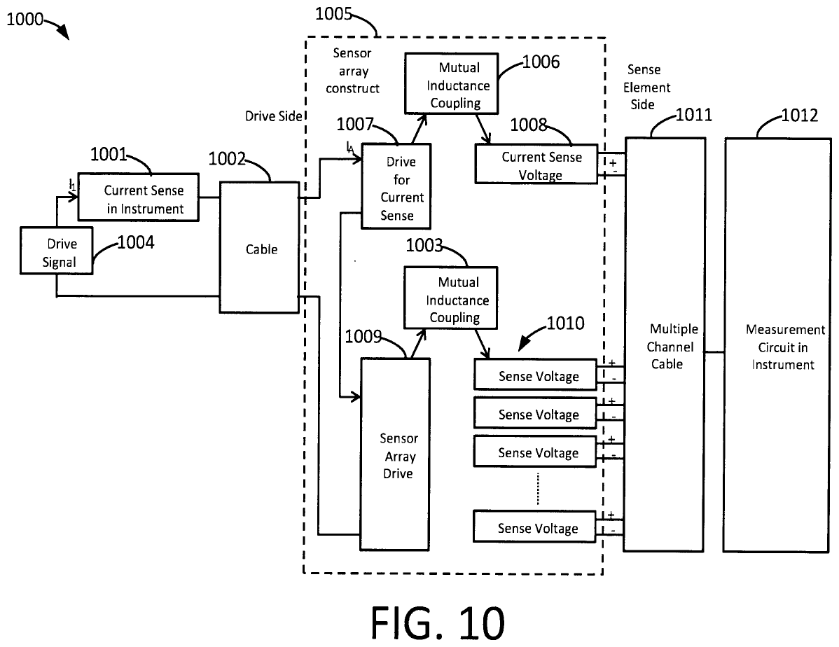

Attention is now turned to FIG. 10 which shows a schematic of a system 1000 according to some embodiments. The impedance measurement instrumentation portion of the system is included in the elements for the drive signal 1004, the current sense in the instrument 1001, and the measurement circuitry in the instrument 1012. The electrical connection from the instrumentation to the sensor array is denoted by cable 1002 while the electrical connections from the sense elements of the sensor array construct 1005 are denoted by the multiple channel cable 1011. Cable 1002 and cable 1011 may be combined into a single cable in some embodiments. The connection from the multiple channel cable 1011 to the measurement circuit 1012 in the instrument typically has multiple conductors as well. In addition, the cable 1002 and the multiple channel cable 1011 may be fabricated onto the same substrate or can be mechanically separate. The sensor array construct 1005 includes the discrete reference sensor used for the current sensing as well as the active portion of the sensor array used to interrogate a test material. The same time-varying current IA is passed from the drive loop for the current sensor 1007 into the sensor array drive loop 1009 as well. Through mutual inductance coupling 1006 and mutual inductance coupling 1003 the drive current generates a voltage on the current sense element 1008 as well as each of the sense elements in the array 1010, respectively. With this configuration, the cable electrical properties, such as the inductance, capacitance, and resistance per unit length on both the drive side as well as the sense element side will affect the measurements. These effects include the actual drive current Ia in the sensor array construct 1005 being different from the drive signal current/7 and the sense voltages on the sense element side of the sensor array construct being different from the voltages passed from the multiple channel cable into the measurement circuit of the instrument. These effects become more pronounced as the cable length and the frequency of the excitation current increase.

Note that the FIG. 10 is shown for a sensor array but this implementation could also be used for a single element sensor. Furthermore, the measurement circuit 1012 of the instrument preferably has multiple dedicated data acquisition circuits for measuring each sense element response voltage in parallel since this allows the sensor array construct itself to be scanned over the surface of the test material quickly. When multiple data acquisition channels are used in the measurement circuit for the instrument, it is preferably to have the number of data acquisition channels be at least one more than the number of sense voltages to be measured in the sensor array. However, a multiplexer could also be used within the measurement circuit of the instrument to allow a smaller number of data acquisition circuits to be used, even one, at the expense of switching between the sense voltages and having a slower scan rate over the surface of the test material.

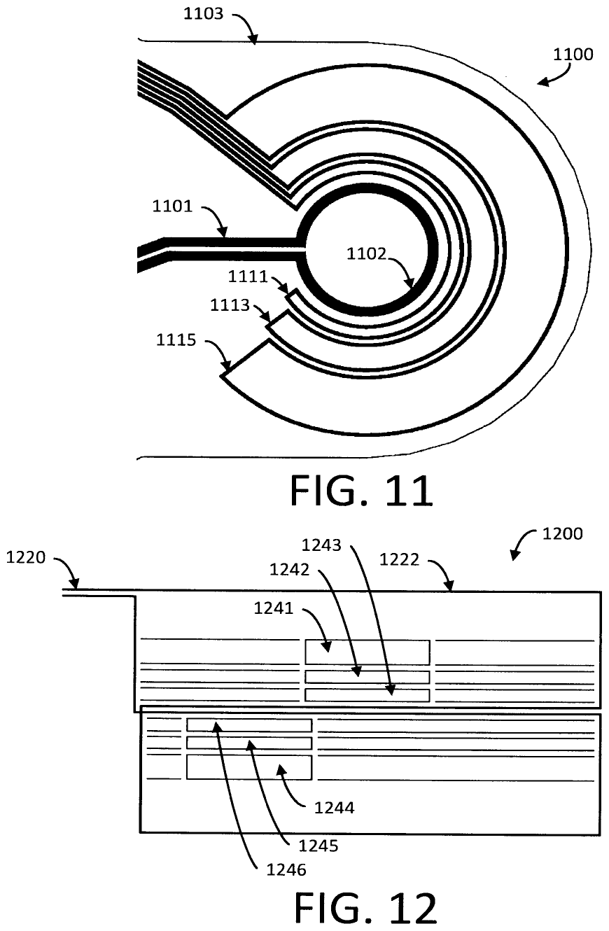

While the previous sensor arrays had a linear row of sense elements, the same approach for using a local current sense can be used with segmented field sensors and arrays. These segmented field sensor constructs have sense elements positioned at different distances from the central portion of the drive winding to couple to different components or segments of the magnetic field. As an illustration of this effect, consider that the depth of penetration of the magnetic field into the test material depends upon both the input current excitation frequency and the sensor geometry such as the distance between the drive winding conductors and the sense element conductors and the distance between drive winding conductors carrying current in opposite directions. This sensor geometry may be summarized as the spatial wavelength. The depth of penetration is limited by the conventional skin depth at high frequencies and by the sensor geometry at low frequencies. At low frequencies the magnetic fields from a larger spatial wavelength sensor will penetrate further into the material under test than the fields from a shorter spatial wavelength sensor. Thus, while small sensor arrays can be used to create high spatial resolution property images, large sensor arrays can be used to examine thick materials and operate in a non-contact mode. FIGS. 11-13 show example segmented sensor constructs. They have sensing elements arrayed at multiple, distinct distances from the drive windings; these are segmented field sensors since the sense elements are sensitive to components of the magnetic field that penetrate to different depths within the test material. Sensor 1100 (FIG. 11) and sensor 1200 (FIG. 12) are considered sensors for monitoring a single location. Sensor 1100 is a circular segmented field sensor with drive conductor 1101, and a near sense conductor 1111, a mid sense conductor 1113, and a far sense conductor 1115. Line 1103 shows an edge of the substrate material for sensor 1100-though only a portion of sensor 1100 is shown. In addition to the second loop portion 1102, drive conductor 1101 may also have a first loop portion (not shown) as well as a current sense conductor (not shown) to construct a remote current sense. Sensor 1200 is another segmented field sensor with a drive conductor 1220 having a second loop portion 1222, and multiple sense conductors having sense loop portions at various wavelengths and in some embodiments multiple lateral positions. As illustrated sensor 1200 has a far sense conductor loop portion 1241, a mid sense conductor loop portion 1242, and a near sense conductor loop portion 1243 centered horizontally on a double-D second loop portion 1222 of drive conductor 1220. Also as illustrated, sensor 1200 has a far sense conductor loop portion 1244, a mid sense conductor loop portion 1245, and a near sense conductor loop portion 1246 offset horizontally on the other side of the double-D second loop portion 1222 of drive conductor 1220. Like sensor 1100, a remote current sensor may be included in sensor 1200 in ways described in connection with sensor 200 and other sensors herein.

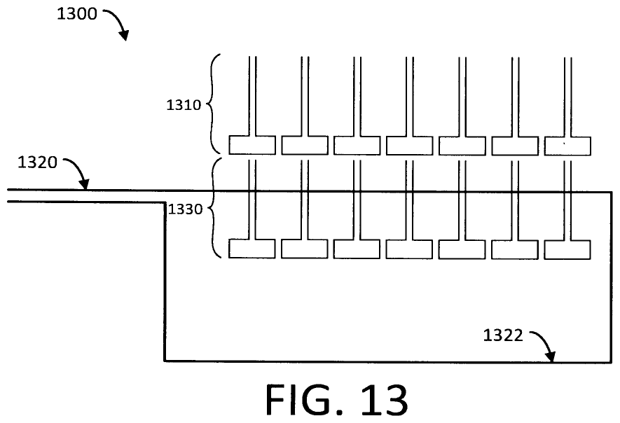

Sensor 1300 (FIG. 13) has two linear arrays of sense elements and is better suited for scanning inspections. Specifically, sensor 1300 has linear area 1310 located outside of a “single-D” second loop portion 1322 of drive conductor 1320 and a linear array 1330 located within the single D second loop portion 1322.

Thus in addition to varying the depth of penetration through electric switching of the excitation frequency, sensors 1100, 1200, and 1300 offer additional information through varied sensor geometry. Similarly, the dimensions of the sensors and the drive conductor and sensing element array designs can be adjusted to provide improved sensitivity based on the properties of the test object that are to be estimated. This includes both the drive spatial wavelength dimension as well as the gap between the drive and the sense elements.

Generally, the dimensions for the sense elements in segmented field sensor constructs are adjusted to provide comparable responses during the calibration and ranging process. (Note that the ranging process involves automatically adjusting drive and/or gain settings in the impedance measurement instrumentation in order to provide the largest measurement signals possible.) This calibration process usually involves the measurement of the sensor or sensor array response to an substantially non-conducting material such as air. Models for the sensor response are commonly used to predict the sensor response as the dimensions are varied. For the associated reference current sense, the same nominal response is preferred. However, if the response from the sense elements vary substantially, it is then preferred to match the current sense response to the median response from the segmented sense elements.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty. The “substantially simultaneous response” means responses measured within 1 second of one another.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method comprising acts of:
(i) providing an eddy current sensor having a sensing element and a remote current sensing element;
(ii) measuring simultaneous first responses of the sensing element and the remote current sensing element while the sensing element and the remote current sensing element are in a known environment;
(iii) determining a calibration factor from the first responses;
(iv) measuring simultaneously second responses of the sensing element and the remote current sensing element, the sensing element proximal to a material under test and the remote current sensing element in the known environment;
(v) dividing the second response from the sensing element by the second response from the remote current sensing element to produce a dividend; and
(vi) calibrating the dividend by applying the calibration factor.

2. The method of claim 1, wherein the known environment is substantially non-conductive and substantially has the magnetic permeability of free space.

3. The method of claim 1, wherein act (i), the sensor further has a drive conductor having a first loop portion with a first width and a second loop portion with a second width, the first loop portion separate from and connected to the second loop portion by a lead portion, the remote current sensing element being proximal the first loop portion, and the sensing element proximal the second loop portion.

4. The method of claim 3, wherein act (i), the first loop portion of the drive conducting is separated from the second loop portion by a distance greater than the first width and the second width.

5. The method of claim 1, wherein act (i), the sensing element is among a plurality of sensing elements forming an array,
act (ii), first responses are measured for each of the plurality of sensing elements,
act (iii), a respective calibration factor is determined for each of the plurality of sensing elements,
act (iv), second responses are measured for each of the plurality of sensing elements,
act (v), the dividing is performed for each of the plurality of sensing elements, and
act (vi), the calibrating is performed for each of the plurality of sensing elements using the respective calibration factor.

6. The method of claim 1, wherein act (vi) the calibrating is performed by multiplying the dividend by the calibration factor.

7. The method of claim 6, wherein the act (iii) further comprises determining an offset, and act (vi) further comprises adding the offset.

8. The method of claim 7, wherein determining the offset comprises measuring a third response of the sensing element on a reference material and of the remote current sensing element in the known environment.

9. The method of claim 1, wherein each of the first and second responses each comprise measurement of two scalar quantities measured simultaneously, the two scalar quantities being mathematically equivalent to (I) a real part and an imaginary part, (II) an in-phase component and a quadrature component, or (III) a magnitude and a phase.

10. The method of claim 1, where the first and second responses are measured at multiple frequencies simultaneously.

11. The method of claim 1, wherein acts (iv), (v), and (vi) are repeated a plurality of times.

12. The method of claim 11, further comprising an act of scanning the sensor across a surface of the material under test during the repeating of acts (iv), (v), and (vi).

13. The method of claim 11, where acts (ii) and (iii) are repeated prior to completing all repetitions of acts (iv), (v), and (vi), and, subsequent the repetition of acts (ii) and (iii) an updated calibration factor is used in subsequent repetitions of act (vi).

14. An eddy current sensor comprising:
a drive conductor having a first loop portion with a first width and a second loop portion with a second width, the first loop portion separated from the second loop by a distance greater than the first width and the second width;
a current sense conductor having a third loop portion proximal to the first loop portion of the drive conductor; and
a sense conductor having a sense loop portion proximal to the second loop portion of the drive conductor.

15. The eddy current sensor of claim 14, wherein the drive conductor, the current sense conductor, and sense conductor are each continuous metal structures fabricated on a flexible substrate.

16. The eddy current sensor of claim 14, wherein the sense conductor is among a plurality of sense conductors forming an array proximal to the second loop portion of the drive conductor.

17. A sensor comprising:
a plurality of electrical terminals including first, second, third, fourth, fifth and sixth electrical terminals;
a drive conductor terminating at the first and second electrical terminals, and having a first loop portion, the first loop portion separate from and connected to the second loop portion by a lead portion;
a current sense conductor terminating at the third and fourth electrical terminals, and having a third loop portion proximal the first loop portion of the drive conductor; and
a sense conductor terminating at the fifth and sixth electrical terminals, and having a sense loop portion proximal to the second loop portion of the drive conductor.

18. The sensor of claim 17, wherein the first loop portion of the drive conductor is separated from the second loop portion by a distance greater than a first width of the first loop portion and a second width of the second loop portion.

19. The sensor of claim 17, wherein the sense conductor is among a plurality of sense conductors forming an array, each sense conductor terminating at a respective pair of terminals among the plurality of terminals and a respective sense loop portion proximal to the second loop portion of the drive conductor.

20. The sensor of claim 17, wherein an area of the third loop portion is within plus or minus 20 percent of an area of the sense loop portion.

21-24. (canceled)
